(19) United States
(12) Patent Application Publication
(10) Pub. No.: US 2025/0384142 A1
(43) Pub. Date: Dec. 18, 2025

(54) AUTOMATICALLY DETECTING AND MITIGATING RISKS ASSOCIATED WITH INSTALLING A SOFTWARE PACKAGE ON A COMPUTER SYSTEM

(71) Applicant: RED HAT, INC., Raleigh, NC (US)

(72) Inventors: Tomas Meszaros, Brno (CZ); Marek Filip, Brno (CZ)

(21) Appl. No.: 18/744,881

(22) Filed: Jun. 17, 2024

(51) Int. Cl. G06F 21/57; G06F 8/61

(52) U.S. Cl. CPC G06F 21/577; G06F 8/61; G06F 2221/033

(57) ABSTRACT

Risks associated with installing a software package on a computer system can be automatically detected and mitigated using techniques described herein. In one example, a system can generate severity scores for software components. Each severity score may correspond to a software component and indicate a severity of its vulnerabilities. The system may generate a risk score based on the severity scores. The risk score may represent an overall level of risk associated with installing the software package on the computing device. The system may also determine that an alternative software component is correlated with a software component of the software package, determine respective severity scores for the software component and the alternative software component, and compare their respective severity scores. The system can determine that the severity score of the alternative software component is lower and output a notification indicating the risk score and the alternative software component.

### TECHNICAL FIELD

The present disclosure relates generally to software installation on a computer system. More specifically, but not by way of limitation, this disclosure relates to automatically detecting and mitigating risks associated with installing a software package on a computer system.

### BACKGROUND

Software packages may have several associated vulnerabilities, exposures, and other risks unknown to a software user who wants to install the software packages. Each individual version of the software package may include a large number of software components, where each software component may have one or more associated vulnerabilities. Examples of such vulnerabilities can include viruses, malware, or other risks associated with a software component.

### BRIEF DESCRIPTION OF THE DRAWINGS

FIG. 1 is a block diagram of an example of a system for automatically detecting and mitigating risks associated with installing a software package on a computer system according to some aspects of the present disclosure.

FIG. 2 is a block diagram of an example of a system detecting and mitigating risks associated with installing a software package on a computer system according to some aspects of the present disclosure.

FIG. 3 is a flow chart of an example of a process for automatically detecting and mitigating risks associated with installing a software package on a computer system according to some aspects of the present disclosure.

FIG. 4 is a flow chart of an example of a process for improving an installation process for a software package by installing lower-risk components according to some aspects of the present disclosure.

FIG. 5 is a flow chart of an example of a process for determining a level of risk associated with installing a software package according to some aspects of the present disclosure.

FIG. 6 is a block diagram of an example of a system for automatically detecting package differences, in addition to detecting and mitigating risks associated with installing a different package on a computer system, according to some aspects of the present disclosure.

### DETAILED DESCRIPTION

A user may wish to install a software package on a computing device such as the user's personal or work computer. The software package may include a large number of software components, such as dozens or hundreds of software components. Each of the software components may be discrete from one another and interact with one another. When installing the package onto the computing device, the user may not know the vulnerabilities or inefficiencies associated with any given software component within the larger software package. For example, one software package, such as a database package, may be associated with a known vulnerability, which the user may be unaware of. And because there may be so many software components in a single software package, it may not be practical for the user to manually try to identify the vulnerabilities and inefficiencies associated with each individual software component. This may result in the user inadvertently installing vulnerable or inefficient software components, which can have a significant impact on the security and efficiency of the computing device.

Some examples of the present disclosure can overcome one or more of the abovementioned problems by automatically detecting risks associated with installing a software package in a computer environment, thereby allowing a user to know in advance of any problems so that the user can take preventative or remedial actions. As an example, a system can receive, from a user, a request to update a software package on a computing device from a first version to a second version. The software package can include one or more software components. In response to receiving the request, the system may automatically generate severity scores for each of the software components in the software package. Each severity score generated by the system can correspond to a specific software component and indicate a severity of one or more vulnerabilities associated with the respective software component. The system may then generate an overall risk score for the software package based on the previously generated severity scores. The overall risk score can represent an overall risk associated with installing the software package on the computing device. For each software component that has a higher severity score (and is thus higher risk), the system may then determine whether an alternative software component exists that could be used as a lower-risk substitute for the high-risk software component to reduce the overall riskiness of the installation. The system may then output a notification indicating the overall risk score and the alternative software components to the user, prior to the computing device installing the software package. This may allow the user to better understand the riskiness of completing the software installation and some potential options to mitigate those risks, before the installation takes place.

In some examples, the system may generate the overall risk score for the software package based on source code for the software package. For example, the system can retrieve the source code associated with the software package, and then generate a quality score associated with the software package by analyzing the source code. The system may determine the quality score based on one or more performance metrics associated with the source code and/or one or more programming errors associated with the source code. Then, the system may generate the risk score based on the quality score. Thus, in some cases, the risk score can be based on a quality score associated with the software package source code or based on known severity scores associated with particular software components of the software package.

Using the techniques described above, the system may be able to preemptively notify a user the effects of installing a requested software package before the software package is installed. Where a software package includes hundreds of software components, each with different potential vulnerabilities and inefficiencies, a user may quickly be provided with useful information such as a summary of the vulnerabilities and a concise risk score associated with installing the software package more generally. Additionally, the techniques described herein can indicate to the user alternative software components that are functionally similar to, and capable of replacing, the software components with more severe vulnerabilities, which can allow the user to still install the software while reducing the potential negative impacts of doing so.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

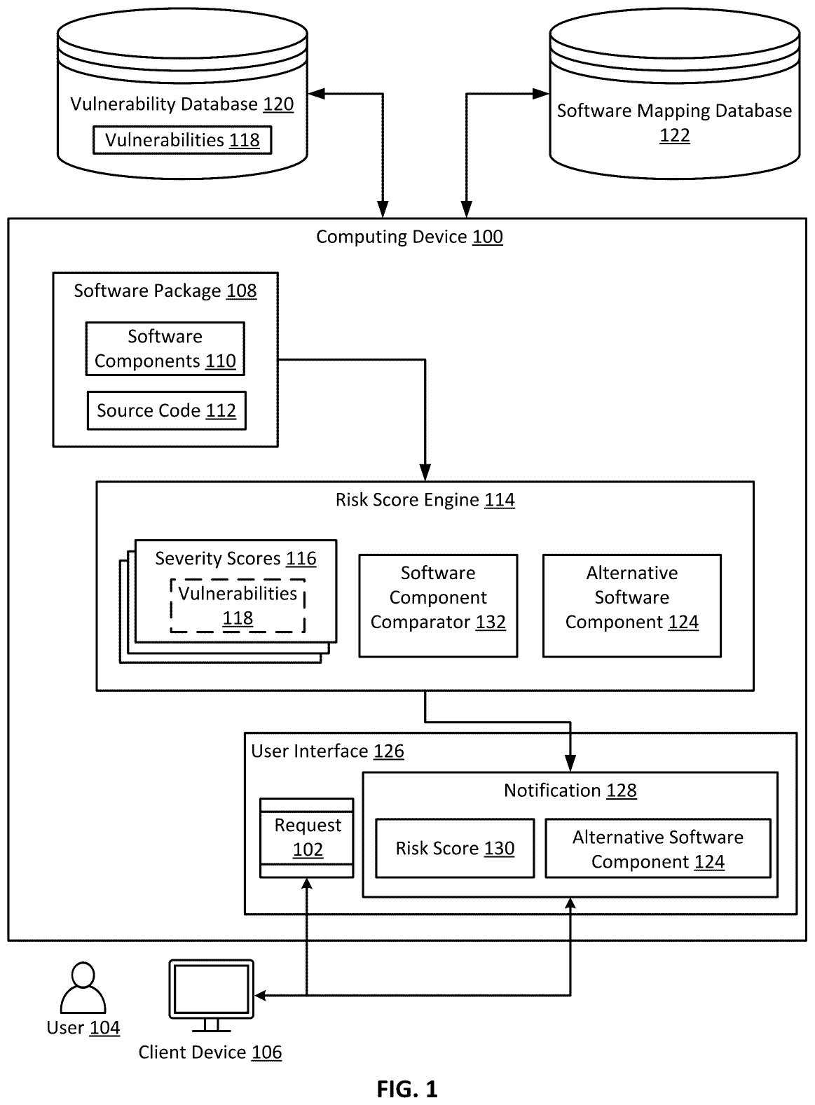

Turning now to FIG. 1, FIG. 1 shows a block diagram of an example of a system for detecting and mitigating risks associated with installing a software package 108 on a computer system according to some aspects of the present disclosure. The system includes a computing device 100 with a risk score engine 114. Examples of the computing device 100 can include a laptop computer, a desktop computer, a server, a mobile phone, or a tablet. The computing device 100 can be communicatively coupled to one or more databases, such as a vulnerability database 120 and a software mapping database 122.

The risk score engine 114 can be configured to provide notifications 128 through a user interface 126 displayed on a client device 106 to a user 104. Examples of the client device 106 can include a laptop computer, a desktop computer, a mobile phone, or a tablet. The risk score engine 114 may receive a request 102 from a user 104, via the client device 106, to install a software package 108. The software package 108 may comprise a bundled collection of computer programs, files, and/or documents. The software package 108 may include one or more software components 110 and may include source code 112. In one example, the software package 108 may comprise an image file for deploying containerized applications or virtual machines in a distributed computing environment.

The software components 110 that make up a software package 108 can be any combination of applications, libraries, or other files. Generally, each software component will be identified as performing a discrete task within the larger software package 108. In some examples, each software component can be mapped in the software mapping database 122 to at least one alternative software component, which has been identified as being functionally similar to the software component and which is compatible with the larger software package 108.

In response to receiving the request 102, the risk score engine 114 may then transmit queries to the vulnerability database 120 and the software mapping database 122. The queries can be for retrieving information about the software package 108 and its constituent software components 110.

For instance, the information retrieved by the risk score engine 114 can include a list of one or more vulnerabilities 118 associated with each software component 110, as retrieved from the vulnerability database 120. Vulnerabilities 118 may include known viruses, malware, and other risks associated with a software component. For example, the vulnerability database 120 may store a predefined list of vulnerabilities associated with various software components, where the list can be used to determine which vulnerabilities correspond to the software components 110 in the software package 108.

The information retrieved by the risk score engine 114 can also include information stored in a software mapping database 122. Generally, the software mapping database 122 stores mappings (e.g., correlations) between software components that are functionally similar, for example because they can perform the same or similar tasks in the same or similar ways. The mappings may be predefined. For instance, a first software component, such as a first library, can perform a similar function to a second library. So, an association between the first library and the second library can be stored in the software mapping database 122. When the risk score engine 114 queries the software mapping database 122 with a specific software package 108 or software component 110, the risk score engine 114 can retrieve at least one alternative software component 124 capable of performing similar functions from the software mapping database 122.

In FIG. 1, the vulnerability database 120 and the software mapping database 122 are shown as separate from, but communicatively coupled to, the computing device 100. But in other examples, the vulnerability database 120 and/or the software mapping database 122 may be stored within the computing device 100. The vulnerability database 120 and the software mapping database 122 may also be stored as a single database, rather than separate databases, in other examples.

The risk score engine 114 may retrieve information from the vulnerability database 120 and the software mapping database 122. For instance, the risk score engine 114 may retrieve an alternative software component 124 from the software mapping database 122 and transmit the alternative software component 124 to the risk score engine 114, so that the risk score engine can determine a severity score 116 associated with the alternative software component 124 based on vulnerabilities 118 associated with the alternative software component 124.

The risk score engine 114 may also include a software component comparator 132 for comparing a particular software component of the software package 108 with an alternative software component 124 as retrieved by the risk score engine 114. The software component comparator 132 may, for instance, compare a first severity score associated with each software component 110 against a second severity score of its corresponding alternative software component 124 to determine which component has the greater severity score. As described in greater detail below, if the software component has the greater severity score, it may be replaced with the alternative software component 124 in the installation process to reduce the riskiness of the installation.

The risk score engine 114 can generate a risk score 130 based on the severity scores 116 of each software component 110 for output through a notification 128 in the user interface 126. The risk score 130 can also be referred to herein as an overall risk score, because it can identify an overall risk associated with installing the requested software package 108. The risk score 130 can be presented as a percentage or a normalized rating indicating the potential impact of the software package 108. The risk score 130 may be provided in the notification 128, in addition to the severity scores 116 and/or the vulnerabilities 118 associated with each of the software components 110. The notification 128 can also include a list of alternative software components 124 that can serve as alternatives to the software components in the installation process. For instance, the risk score engine 114 may generate as part of the notification 128 a list of each alternative software component 124 which has a lower severity score compared to the associated software component 110 of the requested software package 108, as determined by the software component comparator 132. The notification 128 may be generated by the risk score engine 114 and output on a user interface 126 displayed on the client device 106. For instance, the notification may be output on the same user interface 126 and client device 106 used by the user 104 to initiate the request 102.

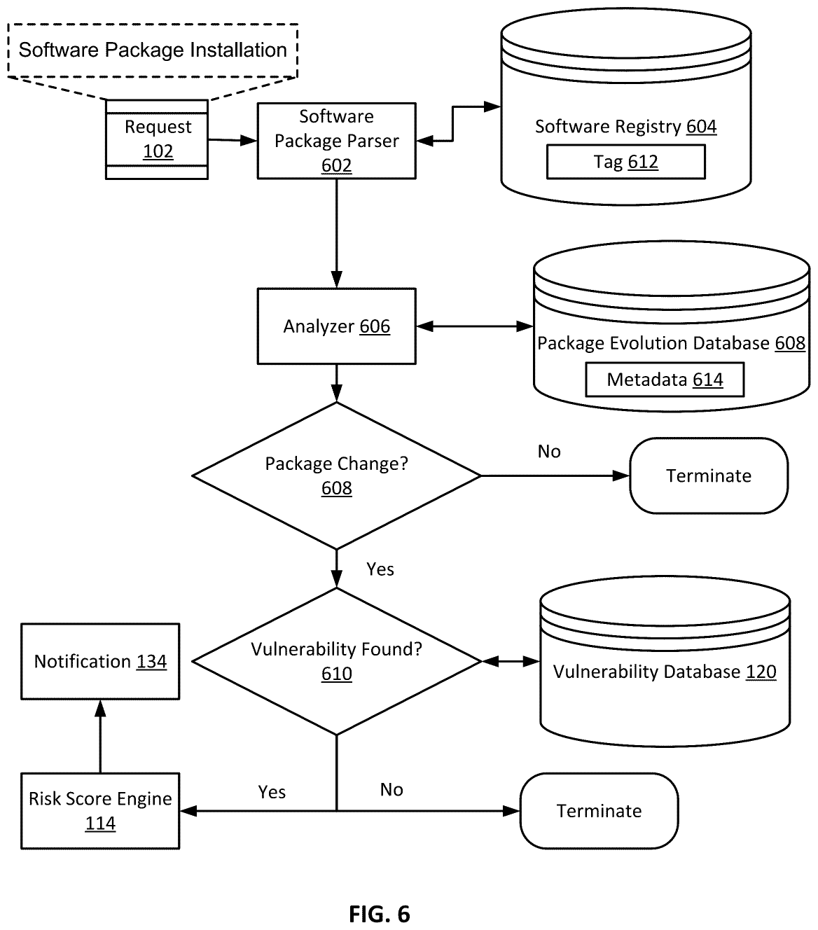

As one particular example, the risk score engine 114 can determine respective severity scores and alternative software components for each version of a software package 108 requested to be installed by a user 104. For instance, a user may request to install version 8.7 of a software package. Version 8.7 may include multiple software components such as a database component and a PHP component. The risk score engine 114, working with a package evolution database and an image registry described further in the example of FIG. 6, can first obtain a list of newer tags for the base software package version 8.7, including tags for the database and the PHP component by aid of the image registry. Then, the package evolution database can evaluate each installed package with respect to all newer tags. If the package evolution database detects changes in any newer software version, for instance Version 8.8 or 8.9, the risk score engine 114 can perform similar processes as described above in which the risk score engine generates severity scores with the each software version, and identifies alternative software components among each version of the software. The resulting notification 128 can then indicate a risk score associated with each version 8.7, 8.8, and 8.9, in response to the user requesting to install version 8.7.

Changes detected by the package evolution database can be indicated by metadata related to the software package 108 or each of the software components 110. For instance, metadata may indicate that a software program was removed in a newer version of the software package, or otherwise split, merged, deleted, renamed, replaced, or otherwise modified between software package versions. If the package evolution database detects any such change as indicated by the metadata, the package evolution database can trigger the risk score engine 114 to generate severity scores associated with the change in the software program or package. Detected changes may also trigger the risk score engine 114 to determine alternative software components 124 for the changed software component 110. In some examples, the risk score engine 114 may execute upon a user request 102 to install a software package 108, regardless of whether changes are detected by the package evolution database.

In some examples, the computing device on which the software package 108 is to be installed is different from the computing device 100 that has the risk score engine 114. For example, the user 104 may wish to install the software package 108 on a target computing device such as the client device 106. So, the user 104 may transmit a request 102 to the computing device 100, to receive guidance about installing the software package 108 on the target computing device. Because the same software components may operate differently on different computing devices, in some examples the request 102 can include one or more characteristics of the target computing device on which the software package 108 is to be installed. The risk scoring engine 114 can receive those device characteristics and take them into account when developing the risk score 130 and other outputs. For example, the vulnerability database 120 may include a list of vulnerabilities 118 that are not only mapped to certain software components, but also certain device characteristics. When retrieving the relevant vulnerabilities from the vulnerability database 120, the risk score engine 114 may obtain the vulnerabilities that match both the software components and the characteristics of the target computing device on which the software package 108 is to be installed. As another example, the software mapping database 122 may include a list of alternative software components that are not only mapped to the software components in the software package 108, but also to certain device characteristics. When retrieving the relevant alternatives from the software mapping database 122, the risk score engine 114 may obtain the alternatives that match both the software components and the characteristics of the target computing device on which the software package 108 is to be installed. In this way, the notification 128 can be customized not only based on the software package 108 that is to be installed, but also based on the characteristics of the target computing device on which the software package 108 is to be installed.

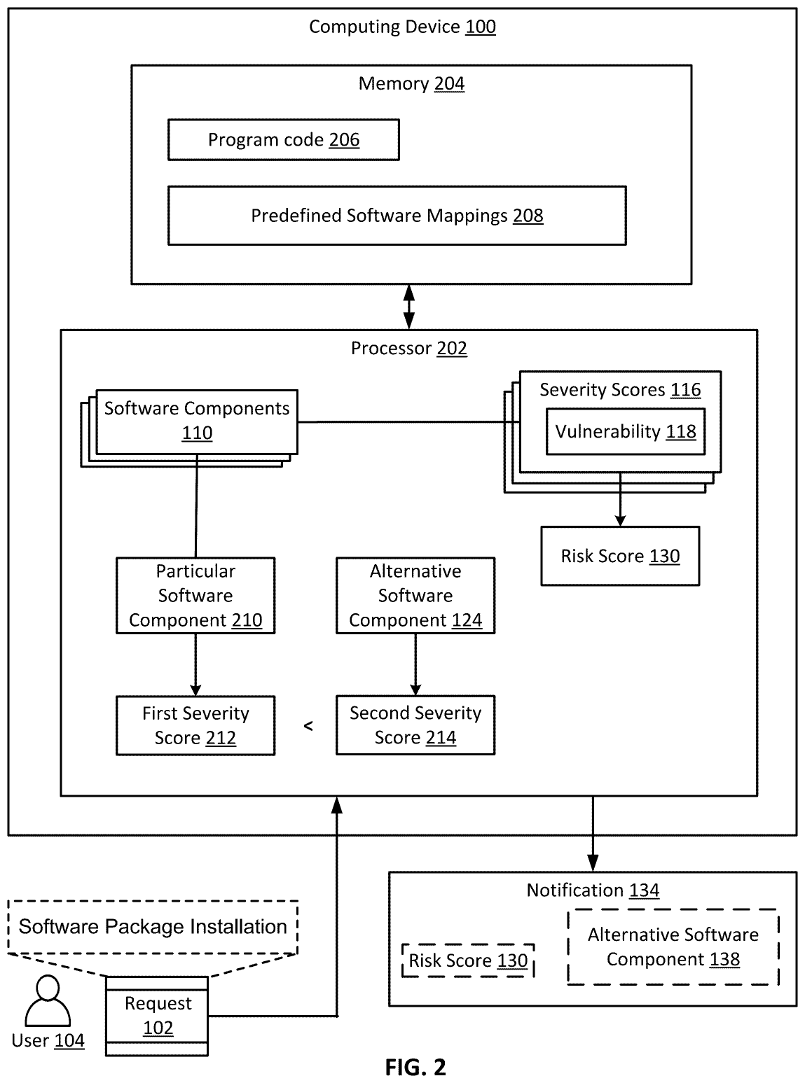

Turning now to FIG. 2, FIG. 2 shows a block diagram of an example of a system detecting and mitigating risks associated with installing a software package on a computer system according to some aspects of the present disclosure. The example system of FIG. 2 includes a processor 202, a memory 204, and program code 206 that is executable by the processor 202.

The processor 202 can include one processor or multiple processors. Non-limiting examples of the processor 202 include a Field-Programmable Gate Array (FPGA), an application-specific integrated circuit (ASIC), a microprocessor, or a combination thereof. The processor 202 can execute program code 206 stored in the memory 204 to perform operations. In some examples, the program code 206 can include processor-specific instructions generated by a compiler or an interpreter from code written in any suitable computer-programming language, such as C, C++, C#, and Java.

The memory 204 can include one memory or multiple memories. Memory 204 can be volatile or non-volatile (e.g., any type of memory device that retains stored information when powered off). Non-limiting examples of memory 204 include electrically erasable and programmable read-only memory (EEPROM), flash memory, or any other type of non-volatile memory. At least some of the memory 204 includes a non-transitory computer-readable medium from which the processor 202 can read program code 206. A computer-readable medium can include electronic, optical, magnetic, or other storage devices capable of providing the one or more processors 202 with computer-readable program code 206 or other instructions. Examples of a computer-readable medium can include magnetic disks, memory chips, ROM, random-access memory RAM, an ASIC, a configured processor, optical storage, or any other medium from which a computer processor can read program code or instructions. In some examples, the memory 204 can store data retrieved from databases including the vulnerabilities from the vulnerability database 120, or predefined software mappings 208 from the software mapping database 122.

In some examples, the processor 202 can execute the program code 206 to perform any of the operations described herein. For example, the processor 202 may receive a request 102 from a user 104. In the example of FIG. 2, the request 102 is associated with installing a particular software package onto a computing device which may or may not be the computing device 100. In response to receiving the request 102, the processor 202 may generate severity scores 116, each corresponding to a respective software component 110 of the requested software package. A first severity score 212 may be generated with respect to the particular software component 210, and a second severity score 214 may be generated for the alternative software component 124. The processor 202 may further generate a risk score 130 based on the plurality of severity scores. The processor 202 may then output a notification 128 indicating the risk score 130 and/or a list of alternative software components 124 with severity scores lower than those associated with a particular software component 210 of the software package. The processor 202 may output the notification 128 to the user 104 prior to the processor 202 installing the software package 108 onto the computing device per the request 102.

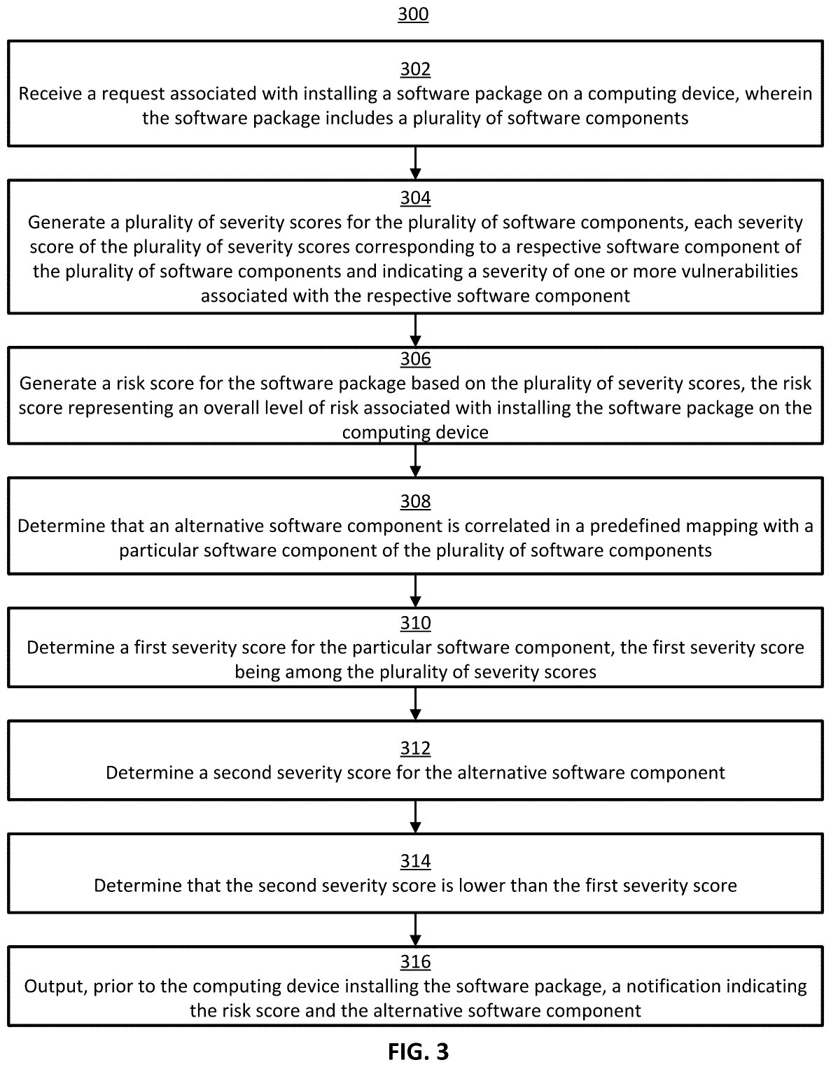

Turning now to FIG. 3, FIG. 3 shows a flow chart of an example of a process for automatically detecting and mitigating risks associated with installing a software package on a computer system according to some aspects of the present disclosure. Other examples may include more operations, fewer operations, different operations, or a different order of the operations shown in FIG. 3. The operations of FIG. 3 will now be described below with reference to the components of FIGS. 1 and 2.

In block 302, the processor 202 receives a request 102 associated with installing a software package 108 on a computing device 100, wherein the software package 108 includes a plurality of software components 110. The request 102 may be received from a user 104 as input into a user interface 126.

In block 304, the processor 202 generates a plurality of severity scores 116 for the plurality of software components 110, each severity score of the plurality of severity scores 116 corresponding to a respective software component of the plurality of software components 110 and indicating a severity of one or more vulnerabilities 118 associated with the respective software component. Vulnerabilities 118 may include, for instance, malware known to be associated with a particular software component 210, as retrieved from a vulnerability database 120. The processor 202 may determine each severity score based on a likelihood that a vulnerability will be exploited weighed against the potential effects if the vulnerability was exploited. Alternatively, the processor 202 may determine the first severity score 212 primarily on the potential effects of the vulnerability being exploited.

In some examples, the processor 202 may calculate each of the plurality of severity score 116 by translating the likelihood the vulnerability of a given software component will be exploited, and the effects of the vulnerability being exploited, into normalized scores out of 10. In some such examples, a score of 1 indicates a low likelihood of the vulnerability being exploited, or minimal negative effects associated with the vulnerability, and a score of 10 indicating that a computing device is highly susceptible to the vulnerability and that the vulnerability would be catastrophic to the computing device if exploited. The normalized scores may then be summed or averaged to generate each severity score 116.

In block 306, the processor 202 generates a risk score 130 for the software package based on the plurality of severity scores 116, the risk score 130 representing an overall level of risk associated with installing the software package 108 on the computing device 100. The processor 202 may generate the risk score 130 based on the severity scores 116 relative to the target computing device. For example, severity scores 116 may indicate vulnerabilities 118 mapped to particular device characteristics. In such cases, the risk score 130 for one target computing device may be greater or lesser than the risk score 130 for another computing device despite the same vulnerabilities being identified. Additionally, or alternatively, the risk score 130 may be calculated based on comparing first severity scores 212 with second severity scores 241 associated with alternative software components 138. For instance, the risk score 130 may be higher if a particular software component 210 of the requested software package is identified with an alternative software component 124 having a lower severity score. In some examples, the processor 202 may calculate the risk score 130 by summing or averaging the severity scores 116 of each software component 110.

In block 308, the processor 202 determines that an alternative software component 124 is correlated in a predefined software mapping 208 with a particular software component 210 of the plurality of software components 110. The correlation between the alternative software component 124 and the particular software component 210 may be based on the functionality of the alternative software component 124 being similar in type to the particular software component 210. For instance, a particular software component 210 of the software package 108 may include a data compression algorithm that takes in as input a particular file size and outputs a reduced file size version of the input file. The processor 202 can identify an alternative software component that similarly includes a data compression algorithm that takes in the same input file type and outputs a reduced size file version similar to the particular software component 210.

The processor 202 may analyze each software component of the software components of the software package 108 to determine whether an alternative software component 124 is correlated, in a predefined software mapping 208, with a particular software component 210.

In block 310, the processor 202 determines a first severity score 212 for the particular software component 210, the first severity score 212 being among the plurality of severity scores 116. The first severity score 212 may indicate the number of vulnerabilities and/or the severity of the vulnerabilities associated with the particular software component 210.

In block 312, the processor 202 determines a second severity score 214 for the alternative software component 124. The second severity score 214 may be computed using similar techniques as the first severity score 212. The alternative software component 124 may be capable of functionally replacing the particular software component 210 within the context of the software package 108.

In block 314, the processor 202 determines that the second severity score 214 is lower than the first severity score 212. This may mean that the alternative software component 124 is less risky to install than particular software component 210. In other examples, the processor 202 may determine that the second severity score 214 is greater than the first severity score 212. This may mean that the alternative software component 124 is more risky to install than particular software component 210, in which case the processor 202 may maintain the particular software component 210 as part of the installation process rather than replacing it with the alternative software component 124.

In block 316, the processor 202 outputs, prior to the computing device 100 installing the software package 108, a notification 128 indicating the risk score 130 and the alternative software component 124. The notification 128 may be output to the user 104 on the same client device 106 and user interface 126 as was used to initiate the request 102. The notification 128 may include a request for approval to proceed before performing the software package 108 installation per the original request 102. Thus, the user 104 may be able to terminate the software package installation request 102 upon receipt of the notification 128, prior to the installation.

In some examples, the notification 128 can include a list of one or more alternative software components 124 with lower severity scores as compared to a particular software component 210 in the software package 108, and prompt the user for permission to replace the particular software components 210 with one of the alternative software components 124. If permission is granted, the processor 202 may perform the installation process but replace the particular software components 210 with the selected alternative software component 124.

When the notification 128 includes the list of one or more alternative software components 124, the notification 128 can include a comparison between an initial risk score 130 associated with the original software package 108 and a modified risk score after potential changes to the installation are made by replacing a particular software component 210 with an alternative software component 124. For example, the processor 202 may identify three alternative software components 124 with lower severity scores 116 compared to the their associated software components from the software package 108. The processor 202 can calculate one or more modified risk scores 130 based on whether the particular software components 210 are replaced with the alternative software components 124. The processor 202 may then display the one or more modified risk scores 130 as part of the notification 128. This can indicate to the user 104 how each alternative software component 124, alone or in combination with the other alternative software components, would reduce the riskiness associated with installing the software package 108. In this way, a user 104 may be able to control and balance the level of risk associated with installing software packages with the potential of using alternative software components 124 to mitigate the risk.

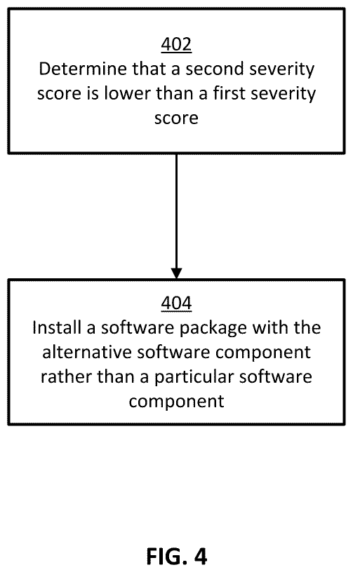

Turning now to FIG. 4, FIG. 4 shows a flow chart of an example of a process for improving an installation process for a software package by installing lower-risk components according to some aspects of the present disclosure. Other examples may include more operations, fewer operations, different operations, or a different order of the operations shown in FIG. 4. The operations of FIG. 4 will now be described below with reference to the components of FIGS. 1 and 2.

In block 402, the processor 202 determines that a second severity score 214 is lower than a first severity score 212, for example by comparing the first severity score 212 to the second severity score 214. The second severity score 214 may be associated with an alternative software component 124 identified by the processor 202, while the first severity score 212 is associated with a particular software component 210 within the software package 108 to be installed. The first severity score 212 and the second severity score 214 may be computed as described above with respect to blocks 310-312 of FIG. 3.

In block 404, the processor 202 installs a software package 108 with the alternative software component, rather than the particular software component 210 that is part of the software package 108 by default. Thus, in the example of FIG. 4, the processor 202 can modify the installation process for the software package 108 by replacing the particular software component 210 the is present in the software package 108 by default with alternative software component 124, which may have been identified as performing similar functions as the particular software components 210, to reduce the risk score 130 associated with installing the software package 108. The processor 202 may perform such tasks automatically and then generate a notification 128 indicating to the user 104 that one or more software components 110 were automatically replaced with alternative software components 124.

In some examples, the user 104 can configure the risk score engine 114 executed by the processor 202 to require permission for some alternative software component 124 replacements, while allowing other alternative software component replacements to be performed automatically, as in block 404. For instance, the user may configure the risk score engine 114 to request approval for all alternative software component replacements that do not reduce the risk score 130 below a threshold value. As an example, if an alternative software component 124 would reduce the risk score 130 of the software package installation 1%, the risk score engine 114 may be configured to generate a notification 128 requesting user approval to replace the associated software component 110 of the software package 108 with the alternative software component 124. However, an alternative software component 124 identified as reduce the risk score 130 of the software package installation 10%, the risk score engine 114 may be configured to automatically replace the software components, as in block 404, and then notify the user 104 that the software components were replaced.

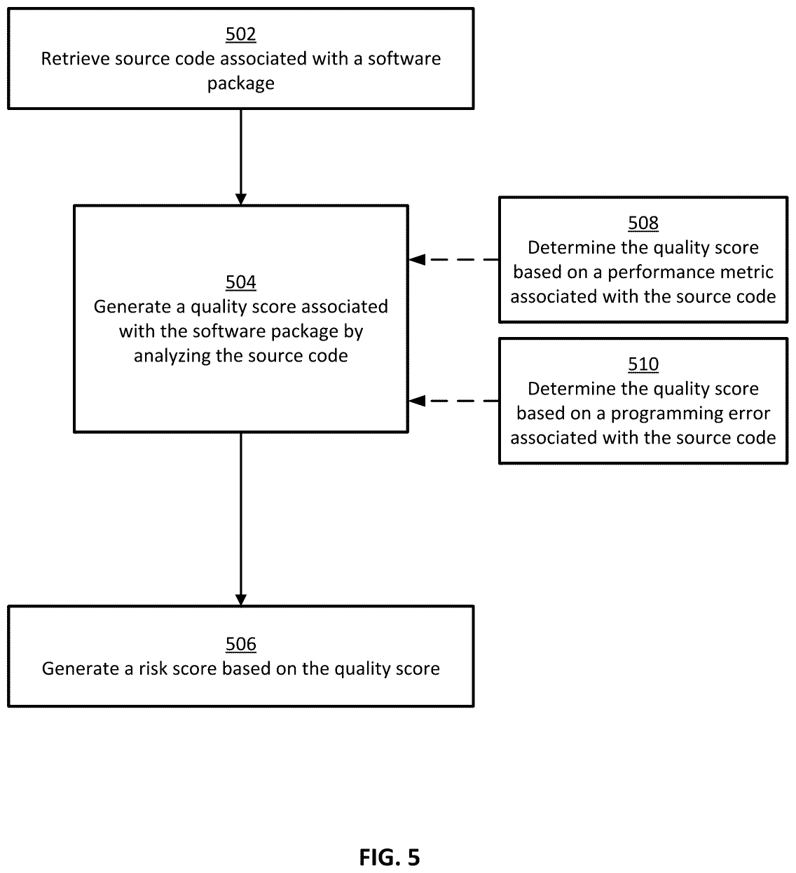

Turning now to FIG. 5, FIG. 5 shows a flow chart of an example of a process for determining a level of risk associated with installing a software package according to some aspects of the present disclosure. Other examples may include more operations, fewer operations, different operations, or a different order of the operations shown in FIG. 5. The operations of FIG. 5 will now be described below with reference to the components of FIGS. 1 and 2.

In block 502, the processor retrieves source code 112 associated with a software package 108. The source code 112 may be associated with the software package 108 generally or may be associated with each specific software component 110 of the software package 108.

In block 504, the processor generates a quality score associated with the software package 108 by analyzing the source code 112. The quality score may include a variety of metrics indicating the functionality or efficiency of the source code 112. For instance, blocks 508 and 510 indicate methods of generating the quality score based on characteristics associated with the source code 112.

In block 508, the processor 202 determines the quality score based on a performance metric associated with the source code 112. The performance metrics may indicate the burden on the processor 202 or the memory 204. Examples of the performance metrics may include throughput, latency, time, and complexity (for instance defined by Big O performance). The quality score may be determined based on a predetermined prioritization of various performance metrics. For instance, the processor 202 may perform a weighted average or weighted summation on the performance metrics, where some metrics are weighted higher than others, to compute the quality score. Thus, the processor 202 can weight some performance metrics differently than others in the quality score computation. For instance, latency issues detected within source code may be weighed more heavily or less heavily compared to throughput metrics.

In some examples, to calculate the quality score, the processor 202 may assign normalized scores to source code 112 associated with certain performance metrics, wherein the normalized scores are based on a percent deviation from similar software configurations with baseline performance metrics. For instance, if a software component 110 is identified as 70% as efficient based on its performance metrics compared to an alternative software component 124, the database software component may be assigned a quality score of 3 on a normalized scale out of 10.

As one particular example, the processor 202 may identify that it and/or other processors of a target computing device are at a processing capacity. In response, the processor 202 may adjust the quality score to be more sensitive to performance metrics tied to processor resource consumption. When the processor 202 identifies that it and/or other processors of a target computing device have processing capacity, the processor 202 may render the quality score more tolerant to identified performance metrics associated with the source code 112.

In block 510, the processor 202 determines the quality score based on a programming error associated with the source code. Examples of programming errors may include logical errors, runtime errors, syntax errors, resource allocation errors, and/or interface errors. For example, interface errors may indicate that the source code 112 is compatible with a given processor or computing environment, such as the one on which the software package 108 is to be installed, but the interface error, or warning, may indicate that the source code 112 may not be compatible on other operating systems, and thus may reduce the quality score associated with the software package.

In some examples, the processor 202 may identify programming errors within software package source code 112 by analyzing the software package source code 112 within a debugging application or other source code analysis tool. The source code analysis tools may be communicatively coupled to the processor 202 and computing device 100 through an API. The debugging application or other source code analysis tool can output a number of identified programming errors in the source code 112 of each software component 110 of the software package 108.

In some examples, to calculate the quality score, the processor 202 may assign normalized scores to each software component 110, wherein the normalized score are based on the number of identified programming errors within the source code 112. Lower quality scores may be better than higher quality scores. For instance, no identified errors may output a quality score of 0, whereas greater than five identified errors may result in a software component quality score of 10.

In block 506, the processor 202 generates a risk score 130 based on the quality score. The risk score 130 may be generated based on the severity scores 116, the quality score, or any combination thereof. The processor 202 may generate the risk score 130 by summing or averaging the quality scores as described with respect to blocks 508 and/or 510. The sum or average of quality scores may further be compared against a distribution of summed or averaged quality scores of alternative software components to generate a normalized risk score. For instance, a software package 108 with a summed quality score of 18 (e.g., containing three software components each with a quality score of 6) may be compared with summed quality scores for alternative software packages and may be assigned a normalized risk score of 4 based on being under an average quality score of the alternative software packages.

In some examples, the processor 202 may calculate the risk score 130 based on both the quality scores and the severity scores 116. For instance, the processor 202 may assign a 30% weight to the summed quality scores, and a 70% weight to the summed severity scores 116, then combine the weighted quality scores and severity scores 116 to generate the risk score 130. In some examples, the processor 202 may weigh the quality score more heavily when calculating the risk score in response to detecting that the processor 202, or the processors of a computing environment are at a threshold computing capacity or otherwise overburdened. For instance, a user 104 may request to install a software package 108 on the client device 106, where the software package 108 has a lower quality score due to poor performance metrics. The processor 202 may detect that the processors of the client device 106 are sufficiently far from a threshold computing capacity, and in response, generate a risk score 130 that weighs the quality score of the software package 108 less compared to if the processor 202 were to detect the processors of the client device were closer to or at the threshold computing capacity.

Referring now to FIG. 6, FIG. 6 is a block diagram of an example of a system for automatically detecting package differences, in addition to detecting and mitigating risks associated with installing a different package on a computer system, according to some aspects of the present disclosure. The example system of FIG. 6 may be used in conjunction with the systems and methods of the proceeding examples to determine whether to execute functions of the risk score engine 114.

FIG. 6 includes a request 102 to install a software package onto a computing device. Prior to transmitting the software package to the risk score engine 114, the requested software package may be first transmitted to a software package parser 602. The software package parser 602 may extract information regarding a package by querying a software registry 604. For instance, the software registry 604 may extract one or more tags 612 including older and newer tags for the software package. The tags 612 may identify other versions of a software package or a software component of a given software package.

An analyzer 606 may then query a package evolution database 608 for metadata 614 on package changes for each tag 612 identified by the software package parser 602. The package evolution database 608 may be a data structure that stores metadata 614 related to the software packages, including package differences between the different versions of the software package 108 or software components 110. The package differences may include changes such as whether a software package was renamed, split, merged, deleted, renamed, replaced, or otherwise changed between versions of software programs. The package evolution database 608 may thus indicate changes to packages between two or more versions of the software package. The package evolution database 608 may include a list of multiple packages for which there are differences between different versions of the software package, such as between the first version, second version, and the third version of the software package.

If the analyzer 606 detects any changes in the newer tags 612 related to a given software package or its components, the request 102 may then proceed to a vulnerability identification step 610. Otherwise, if the analyzer 606 does not detect any changes between a currently operating software package and a requested software package, the analyzer 606 may terminate further querying, including any calls to the risk score engine 114.

At the vulnerability identification step 610, the analyzer 606 may query the vulnerability database 120 to detect whether any vulnerabilities are associated with the requested software package and/or any other related software packages, such as one or more newer versions of the software package identified within the package evolution database 608. The analyzer may then call the risk score engine 114 to be applied to each software package version identified as having a vulnerability.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

1. A method comprising:
receiving, by one or more processors, a request associated with installing a software package on a computing device, wherein the software package includes a plurality of software components; and
in response to receiving the request:
generating, by the one or more processors, a plurality of severity scores for the plurality of software components, each severity score of the plurality of severity scores corresponding to a respective software component of the plurality of software components and indicating a severity of one or more vulnerabilities associated with the respective software component;
generating, by the one or more processors, a risk score for the software package based on the plurality of severity scores, the risk score representing an overall level of risk associated with installing the software package on the computing device;
determining, by the one or more processors, that an alternative software component is correlated in a predefined mapping with a particular software component of the plurality of software components;
determining, by the one or more processors, a first severity score for the particular software component, the first severity score being among the plurality of severity scores;
determining, by the one or more processors, a second severity score for the alternative software component;
determining, by the one or more processors that the second severity score is lower than the first severity score; and
outputting, by the one or more processors, and prior to the computing device installing the software package, a notification indicating the risk score and the alternative software component.

2. The method of claim 1, further comprising:
based on determining that the second severity score is lower than the first severity score, installing the software package with the alternative software component rather than the particular software component.

3. The method of claim 1, wherein the alternative software component is a different version of the particular software component.

4. The method of claim 1, wherein the alternative software component is correlated to the particular software component in the predefined mapping based on functional similarities between the alternative software component and the particular software component.

5. The method of claim 1, further comprising outputting, as part of the notification, at least one difference between the particular software component and the alternative software component.

6. The method of claim 1, further comprising generating the risk score by:
retrieving source code associated with the software package;
generating a quality score associated with the software package by analyzing the source code; and
generating the risk score based on the quality score.

7. The method of claim 6, wherein the quality score is determined based on a performance metric associated with the source code.

8. The method of claim 6, wherein the quality score is determined based on a programming error identified within the source code.

9. The method of claim 1, wherein the software package is an image file for deploying an application inside a container.

10. A non-transitory computer-readable medium comprising program code that is executable by one or more processors for causing the one or more processors to perform operations including:
receiving, by one or more processors, a request associated with installing a software package on a computing device, wherein the software package includes a plurality of software components; and
in response to receiving the request:
generating, by the one or more processors, a plurality of severity scores for the plurality of software components, each severity score of the plurality of severity scores corresponding to a respective software component of the plurality of software components and indicating a severity of one or more vulnerabilities associated with the respective software component;
generating, by the one or more processors, a risk score for the software package based on the plurality of severity scores, the risk score representing an overall level of risk associated with installing the software package on the computing device;
determining, by the one or more processors, that an alternative software component is correlated in a predefined mapping with a particular software component of the plurality of software components;
determining, by the one or more processors, a first severity score for the particular software component, the first severity score being among the plurality of severity scores;
determining, by the one or more processors, a second severity score for the alternative software component;
determining that the second severity score is lower than the first severity score; and
outputting, by the one or more processors, and prior to the computing device installing the software package, a notification indicating the risk score and the alternative software component.

11. The non-transitory computer-readable medium of claim 10 wherein the operations further comprise:
based on determining that the second severity score is lower than the first severity score, installing the software package with the alternative software component rather than the particular software component.

12. The non-transitory computer-readable medium of claim 10 wherein the alternative software component is a different version of the particular software component.

13. The non-transitory computer-readable medium of claim 10 wherein the alternative software component is correlated to the particular software component in the predefined mapping based on functional similarities between the alternative software component and the particular software component.

14. The non-transitory computer-readable medium of claim 10 wherein the operations further comprise outputting, as part of the notification, at least one difference between the particular software component and the alternative software component.

15. The non-transitory computer-readable medium of claim 10 wherein the operations further comprise generating the risk score by:
retrieving source code associated with the software package;
generating a quality score associated with the software package by analyzing the source code; and
generating the risk score based on the quality score.

16. The non-transitory computer-readable medium of claim 15 wherein the quality score is determined based on a performance metric associated with the source code.

17. A system comprising:
one or more processors; and
one or more memories including program code that is executable by the one or more processors for causing the one or more processors to perform operations including:
receiving, by one or more processors, a request associated with installing a software package on a computing device, wherein the software package includes a plurality of software components; and
in response to receiving the request:
generating, by the one or more processors, a plurality of severity scores for the plurality of software components, each severity score of the plurality of severity scores corresponding to a respective software component of the plurality of software components and indicating a severity of one or more vulnerabilities associated with the respective software component;
generating, by the one or more processors, a risk score for the software package based on the plurality of severity scores, the risk score representing an overall level of risk associated with installing the software package on the computing device;
determining, by the one or more processors, that an alternative software component is correlated in a predefined mapping with a particular software component of the plurality of software components;
determining, by the one or more processors, a first severity score for the particular software component, the first severity score being among the plurality of severity scores;
determining, by the one or more processors, a second severity score for the alternative software component;
determining that the second severity score is lower than the first severity score; and
outputting, by the one or more processors, and prior to the computing device installing the software package, a notification indicating the risk score and the alternative software component.

18. The system of claim 17, wherein the operations further comprise:
based on determining that the second severity score is lower than the first severity score, installing the software package with the alternative software component rather than the particular software component.

19. The system of claim 17, wherein the alternative software component is a different version of the particular software component.

20. The system of claim 17, wherein the alternative software component is correlated to the particular software component in the predefined mapping based on functional similarities between the alternative software component and the particular software component.
